(19) United States
(12) Patent Application Publication
(10) Pub. No.: US 2011/0091845 A1
(43) Pub. Date: Apr. 21, 2011

(54) Implementation of Facility Management Programs

(76) Inventors: Duff R. Dorschner, Lino Lakes, MN (US); Daniel J. Schwarz, Stillwater, MN (US)

(21) Appl. No.: 12/840,278

(22) Filed: Jul. 20, 2010

Related U.S. Application Data
(60) Provisional application No. 61/271,342, filed on Jul. 20, 2009.

(51) Int. Cl. G09B 19/00

(52) U.S. Cl. 434/219

(57) ABSTRACT

The present invention provides systems and associated user interfaces that allow a service provider to manage predetermined aspects of one or more organization and utilize common aspects of plural managed organizations to advantageously utilize economies of scale associated with such common aspects and provide more efficient management of such organizations.

### CROSS REFERENCE TO RELATED APPLICATIONS

The present application claims priority to U.S. Provisional Application No. 61/271,342 filed Jul. 20, 2009, the entire contents of which is incorporated herein by reference for all purposes.

### TECHNICAL FIELD

The present invention relates generally to systems and associated user interfaces for management of predetermined aspects of one or more organizations such as aspects related to policies, employee performance, business performance, and rules and regulations. More particularly, the present invention relates to systems, such as embodied in computer software, for management of compliance and associated training related to predetermined criteria such as criteria related to workplace health and safety. The present invention also relates to user interfaces for such systems.

### SUMMARY

The present invention provides systems and associated user interfaces that allow a service provider to manage predetermined aspects of one or more organization and utilize common aspects of plural managed organizations to advantageously utilize economies of scale associated with such common aspects and provide more efficient management of such organizations. Accordingly, systems in accordance with the present invention are preferably configured as multi-tenant systems from the perspective of the system service provider. That is, systems in accordance with the present invention are preferably configured to provide services to plural organizations so that each managed organization is isolated from the other from the perspective of users of each organization while the service provider can also take advantage of common aspects of such plural organizations.

In an exemplary aspect of the present invention, systems for managing compliance with and training related to workplace health and safety are provided. Such systems preferably utilize job descriptions that identify workplace hazards that can be encountered in performing the job and written plans that address predetermined workplace hazards. Written plans preferably include information related to safety training courses for identified workplace hazards. Systems in accordance with the present invention are preferably configured to automatically associate workplace hazards with safety training courses. Moreover, systems in accordance with the present invention are preferably configured to automatically associate training courses for a workplace hazard with a job description. Preferably, systems in accordance with the present invention are configured to combine written plans, job descriptions, Job safety analyses, and training courses in a closed loop process.

In another aspect of the present invention a method of implementing a hazard training program is provided. The method comprises inputting a written plan addressing a predetermined hazard into a computer database; indicating in the written plan at least one training module directed to the predetermined hazard; automatically associating in a computer database the predetermined hazard with the at least one training module indicated in the written plan addressing the predetermined hazard; inputting a job description describing a predetermined job into a computer database/memory; indicating in the job description that the predetermined hazard will be encountered in performing the predetermined job; automatically associating the training modules directed to the predetermined hazard with the job description; and indicating in a user readable format that the training modules directed to the predetermined hazard are associated with the job description.

In another aspect of the present invention a method of implementing a hazard training program is provided as described above and further comprises inputting at least one employee identifier into a computer database; associating the at least one employee identifier with a job description; automatically assigning training modules associated with the job description to the at least one employee identifier; and indicating in a user readable format a schedule of the training modules assigned to the at least one employee identifier.

In another aspect of the present invention a computer program user interface for providing information concerning a facility training program is provided. The user interface comprises a first hyperlink indicating at least one department hyperlink associated with the facility, the at least one department hyperlink indicating a training curriculum associated with the at least one department; a second hyperlink indicating at least one job name, the at least one job name having associated therewith at least a job description hyperlink and a job safety analysis; and a third hyperlink indicating written plans for at least one hazard associated with the facility.

In yet another aspect of the present invention a computer program user interface for providing information concerning a facility training program is provided. The user interface comprises at least one written plan name associated with a facility or department, the at least one written plan name including a hyperlink to the complete associated written plan and having associated therewith at least one training module; each training module associated with the at least one written plan; at least one job title associated with the at least one written plan name, the job title having associated with it at least a first hyperlink to a job description associated with the job title and at least a second hyperlink to a job safety analysis associated with the job title; and an indication of the frequency at which each training module must be completed for the job indicated by the at least one job title.

### BRIEF DESCRIPTION OF THE DRAWINGS

The accompanying drawings, which are incorporated in and constitute a part of this disclosure, illustrate several aspects of the present invention and together with description of the exemplary embodiments serve to explain the principles of the present invention. A brief description of the drawings is as follows:

FIG. 1 is a schematic illustration of an exemplary system in accordance with the present invention showing in particular a service provider and plural organizations that receive services from the service provider.

FIG. 2 is an exemplary user interface for providing logon functionality for a service provider that provides a system in accordance with the present invention to one or more organizations.

FIG. 3 is an exemplary user interface in the form of a homepage that can be used by an organization that uses a system in accordance with the present invention.

FIG. 4 is an exemplary user interface for providing logon functionality for a user of a system in accordance with the present invention.

FIG. 5 is an exemplary user interface of a system in accordance with the present invention that provides training information to a user of the system and that can be used to manage such information.

FIG. 6 is an exemplary user interface of a system in accordance with the present invention that can be used by an administrator of a system of the present invention for managing such system.

FIG. 7 is an exemplary user interface of a system in accordance with the present invention that provides department information to a user of the system and that can be used to manage such information.

FIG. 8 is an exemplary user interface of a system in accordance with the present invention that provides additional department information to a user of the system and that can be used to manage such information.

FIG. 9 is an exemplary user interface of a system in accordance with the present invention that provides job description information to a user of the system and that can be used to manage such information.

FIG. 10 is an exemplary user interface of a system in accordance with the present invention that provides additional job description information to a user of the system and that can be used to manage such information.

FIG. 11 is an exemplary user interface of a system in accordance with the present invention that provides additional job description information to a user of the system and that can be used to manage such information.

FIG. 12 is an exemplary user interface of a system in accordance with the present invention that provides additional job description information to a user of the system and that can be used to manage such information.

FIG. 13 is an exemplary user interface of a system in accordance with the present invention that provides additional job description information to a user of the system and that can be used to manage such information.

FIG. 14 is an exemplary job description that can be generated by a system in accordance with the present invention.

FIG. 15 is an exemplary user interface of a system in accordance with the present invention that provides job safety information to a user of the system and that can be used to associate a job description with training courses and a written plan.

FIG. 16 is an exemplary user interface of a system in accordance with the present invention that provides written plan information to a user of the system and that can be used to manage such information.

FIG. 17 is an exemplary user interface of a system in accordance with the present invention that provides additional written plan information to a user of the system and that can be used to manage such information.

FIG. 18 is an exemplary user interface of the system in accordance with the present invention that provides additional written plan information to a user of the system and that can be used to manage such information.

FIG. 19 is an exemplary user interface of a system in accordance with the present invention that provides additional written plan information to a user of the system and that can be used to manage such information.

FIG. 20 is an exemplary user interface of a system in accordance with the present invention that provides additional written plan information to a user of the system and that can be used to manage such information.

FIG. 21 is an exemplary user interface of a system in accordance with the present invention that provides additional written plan information to a user of the system and that can be used to manage such information and that can additionally be used to associate a written plan with a training course.

FIG. 22 is an exemplary written plan that can be generated by a system in accordance with the present invention.

FIG. 23 is an exemplary user interface of a system in accordance with the present invention that provides building information and that can be used to manage such information.

FIG. 24 is an exemplary user interface of a system in accordance with the present invention that provides additional building information and that can be used to manage such information.

FIG. 25 is an exemplary user interface of a system in accordance with the present invention that provides training course information and that can be used to manage such information.

FIG. 26 is an exemplary user interface of a system in accordance with the present invention that provides additional training course information and that can be used to manage such information.

FIG. 27 is an exemplary user interface of a system in accordance with the present invention that provides additional training course information and that can be used to manage such information.

FIG. 28 is an exemplary user interface of a system in accordance with the present invention that provides additional training course information and that can be used to manage such information.

FIG. 29 is an exemplary user interface of a system in accordance with the present invention that provides additional training course information and that can be used to manage such information.

FIG. 30 is a schematic representation of a data management system in accordance with the present invention.

FIG. 31 is an exemplary user interface of a system in accordance with the present invention that provides information related to data management and that can be used to manage such information.

FIG. 32 is an exemplary user interface of a system in accordance with the present invention that provides additional information related to data management and that can be used to manage such information.

FIG. 33 is an exemplary user interface of a system in accordance with the present invention that provides additional information related to data management and that can be used to manage such information.

FIG. 34 is an exemplary user interface of a system in accordance with the present invention that provides additional information related to data management and that can be used to manage such information.

### DETAILED DESCRIPTION

The exemplary embodiments of the present invention described herein are not intended to be exhaustive or to limit the present invention to the precise forms disclosed in the following detailed description. Rather the exemplary embodiments described herein are chosen and described so those skilled in the art can appreciate and understand the principles and practices of the present invention.

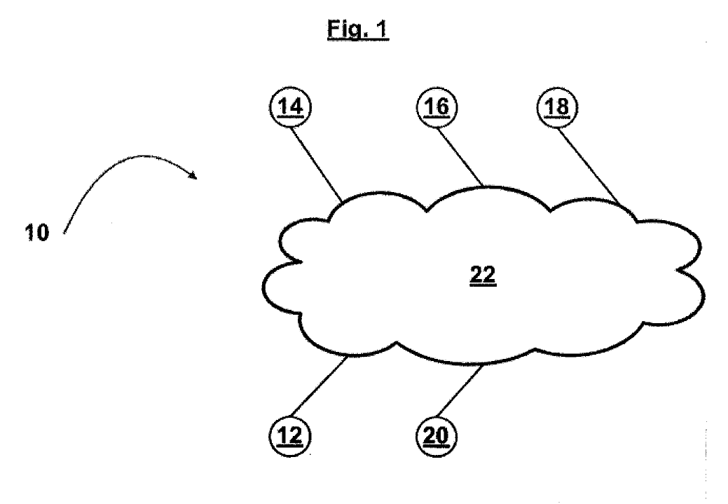

FIG. 1 schematically shows an exemplary embodiment of an implementation of a system 10 in accordance with the present invention. System 10, as described herein, is configured as a health and safety management system including safety training and compliance management and further preferably includes data management functionality. It is understood, however, that the description of system 10 herein is provided for exemplary purposes and that systems in accordance with the present invention can be directed to management of any desired aspects of one or more organizations such as aspects related to policies, employee performance, business performance, and rules and regulations, for example.

Generally, the implementation of system 10 comprises service provider 12 and plural organizations 14, 16, 18, and 20 in communication with each other through network 22 each of which include users that may comprise employee-users or administrator-users. For purposes of describing the exemplary implementation of system 10 shown in FIG. 1 herein, service provider 12 comprises a business organization providing a system in accordance with the present invention as a service to organizations 14, 16, 18, and 20 wherein such organizations may comprise business or nonprofit organizations comprising plural employees also referred to herein as users. Typically, service provider 12 and organizations 14, 16, 18, and 20 exist at distinct physical locations as distinct business or nonprofit organizations. It is understood, however, that organizations as referred to herein do not need to comprise distinct organizations and may comprise different departments within a single organization, for example.

Systems in accordance with the present invention can be configured so that a predetermined organization can provide oversight or management to other predetermined organizations. For example, an organization that provides an oversight role with respect to other organizations can advantageously use systems in accordance with the present invention. An example of such a configuration would be where an insurance company desires to help clients manage health and safety programs or other programs that relate to compliance and associated training or the like. Using systems in accordance with the present invention the insurance company can manage each client as distinct clients and can also benefit from common aspects of such clients because of the multi-tenant aspect of systems in accordance with the present invention. For example, systems in accordance with the present invention provide the ability to share training courses, written plans, job descriptions, and the like between various organizations being managed by systems of the present invention thus providing advantageous economies of scale. In the context of an insurance company, the ability for the insurance company to access and review client data to ascertain compliance with predetermined parameters such as to measure performance against predetermined standards can be advantageously provided by systems in accordance with the present invention.

Systems in accordance with the present invention can also be configured to provide a dashboard or other user interface to an exemplary organization such as an insurance company. Such user interface can be configured to provide predetermined performance parameters or other predetermined measures of compliance or performance to help identify and thereby manage clients based on such compliance or performance or the like, for example.

Systems in accordance with the present invention can also be used to identify and analyze business decision-making information such as risk and effort needed to service a customer, client, organization, or the like. Organizations that may desire to manage other organizations and that can benefit from systems in accordance with the present invention may include insurance companies, consultants, government agencies, holding companies, and venture funds, for example.

Preferably, program instructions related to a system in accordance with the present invention reside on one or more machines such as computers under the control of service provider 12 existing at one or more predetermined location such as the site of the business organization of service provider 12. Employees (users) of organization 14, 16, 18, and 20 can preferably access system 10 by connecting to network 22. For example, employees of an organization may use a web browser or the like of a conventional machine or device comprising a computer to access a system in accordance with the present invention over the Internet. It is understood however, that an employee of an organization can access a system in accordance with the present invention at any location permitted by the system and by any means permitted by the system. That is, a system in accordance with the present invention may allow employees of an organization to access the system at a place of business of the organization or at any permitted remote location. A system in accordance with the present invention may also allow employees of an organization to access the system using devices such as conventional computers or handheld devices such as phones or functionally dedicated devices configured to access the system.

Systems in accordance with the present invention are preferably designed to function as multi-tenant systems at least in that systems in accordance with the present invention can host one or more organizations with the same program instructions. Multi-tenant systems are well understood by those skilled in the art and include systems to manage plural customers and users including user and access permissions, for example. Accordingly, systems in accordance with the present invention can be designed to comprise multi-tenant functionality using any desired known or future-developed software, hardware, communication systems, interfacing browsers, or interfacing software or devices, for example.

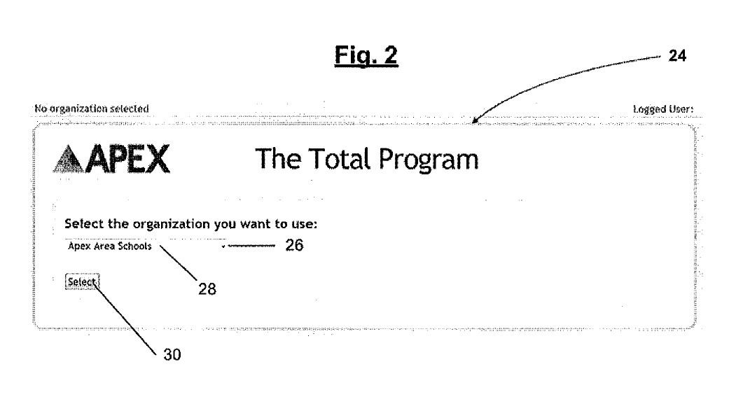

With reference to FIG. 2, an exemplary interface 24 for a system in accordance with the present invention is shown. Interface 24, as shown, includes drop-down list 26 from which a user can select an organization associated with the user or the like from a list of organizations. User interface 24 allows users (employees) of an organization to access a system in accordance with the present invention without the need for a distinct interface for each organization. Additionally, user interface 24 allows an administrator of the service provider 12 to access information related to any desired organization for administrative or management functions.

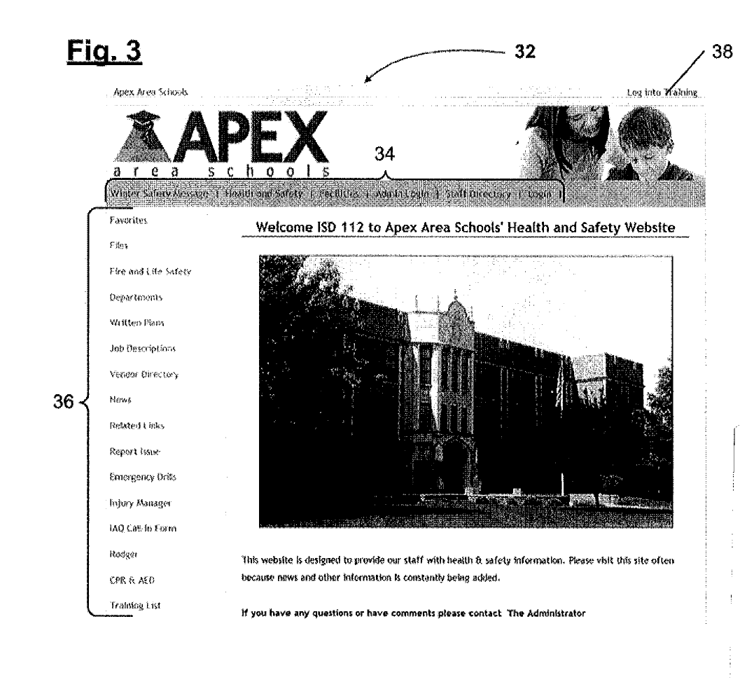

When the desired organization has been selected and appears in window 28 of drop-down list 26 the user can then click select button 30. Clicking button 30 loads a homepage 32, which is illustrated in FIG. 3. Homepage 32 preferably comprises a public Internet website homepage for a specific organization using a system in accordance with the present invention and preferably includes features related to use and administration of the system for that organization. Homepage 32 may comprise the main homepage used for a particular organization or may comprise a hyperlinked page identified on a predetermined desired page of the website of an organization. Moreover, homepage 32 may comprise the homepage of a distinct website specifically dedicated to the system for a particular organization.

For purposes of illustrating and describing the systems of the present invention, portions of an exemplary system in accordance with the present invention are illustrated and described in the form of screenshots that represent what a user of the system would see when using the system. The exemplary system of the present invention described and illustrated herein is provided in the context of an organization that comprises a public school system. Accordingly, homepage 32 shown in FIG. 3 illustrates an exemplary homepage that could be used for such a school system. It is understood, however, that the systems of the present invention are not limited to organizations comprising schools and any organization having a need to manage aspects of organizations described herein can use the systems in accordance with the present invention. For example, organizations that need to provide and manage training related to any of corporate policies, rules, guidelines, safety, continuing education, and law and the like can use and benefit from systems in accordance with the present invention. Moreover, organizations that function as an oversight organization relative to other organizations such as an insurance company, for example.

Homepage 32, as shown, is configured to provide an interface with a system in accordance with the present invention through which any desired user can interact with the system. Continuing to refer to FIG. 3 homepage 32 comprises information including text and graphics that identify the school and which are often referred to as a skin. In a preferred embodiment of the present invention the skin associated with a particular organization is used consistently throughout the windows and user interfaces of the system. Exemplary homepage 32 also comprises a horizontally arranged group of hyperlinks 34 including Health and Safety hyperlink, Admin Login hyperlink, Training Login hyperlink, Staff Directory hyperlink, Facilities hyperlink, and login hyperlink, which preferably function as described. Homepage 32 also comprises a vertically arranged group of hyperlinks 36 including Files hyperlink, Favorites hyperlink, Written Plans hyperlink, Departments hyperlink, Job Descriptions hyperlink, Vendor Directory hyperlink, News hyperlink, Related Links hyperlink, Roger hyperlink, Fire and Life Safety hyperlink, and Fire hyperlink, which preferably function as described. The hyperlinks of horizontally arranged group of hyperlinks 34 and vertically arranged group of hyperlinks 36 are exemplary and preferably defined based on parameters such as the structure, training needs, and compliance requirements, of the organization for example. Moreover, it is noted that each and every hyperlink shown in the Figures is not described. Hyperlinks shown in the Figures are preferably configured to function in a manner consistent with the name of the hyperlink and consistent with the context of the description of systems of the present invention provided herein.

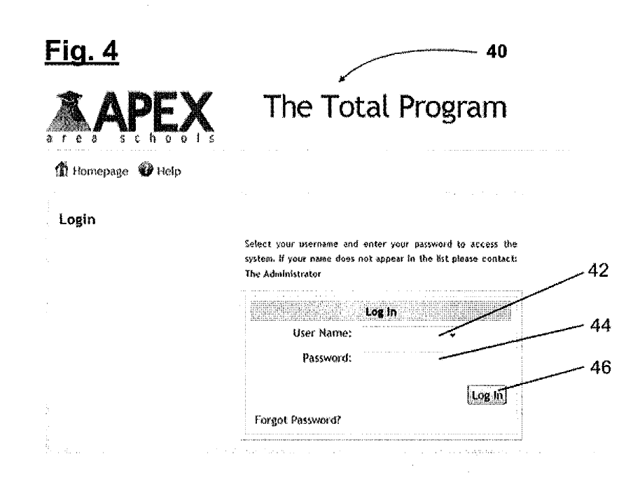

Homepage 32 also comprises Log into Training hyperlink 38 that functions to direct the user to a login screen such as the exemplary login screen 40 shown in FIG. 4 when the user clicks on the Log into Training hyperlink 38. As shown in FIG. 4, login screen 40 comprises user name drop-down list 42, password field 44, and Log In button 46. Preferably, user name drop-down list 42 is pre-populated with users. Any desired procedure can be used for a user to obtain access to the system including those that do not require a secure login technique. Drop-down list 42 may alternatively comprise a text box where a user directly enters a username.

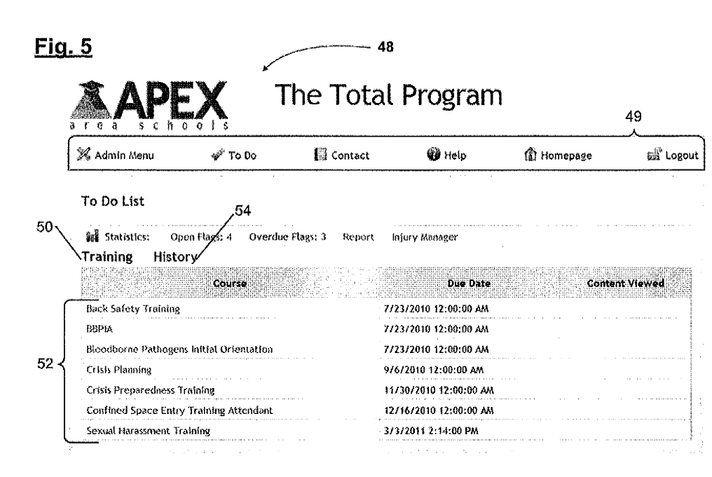

When a user selects a username from drop-down list 42, enters a password into password field 44, and clicks Log In button 46 the system identifies which parts of the system that particular user can access and preferably directs the user to the exemplary Training To Do List Screen 48 shown in FIG. 5. Training To Do List Screen 48 is preferably the first screen that the user encounters after logging in to a system in accordance with the present invention. It is contemplated, however, that the system can direct the user to any desired user interface, screen, or the like.

The exemplary illustrated Training To Do List Screen 48 is preferably specific to the user logged in to the system and preferably provides information including training information to a user such as a typical employee user. For example, referring to FIG. 5 Training To Do List Screen 48 is shown in the state where Training hyperlink 50 defines what is shown in Training To Do List Screen 48. That is, Training hyperlink 50 has been selected instead of History hyperlink 54. As shown, Training To Do List Screen 48 provides a list of training courses 52 and the dates that such courses are scheduled to be completed by the user. Training To Do List Screen 48 also preferably includes a group of hyperlinks 49 that provide common functionality. Accordingly, group of hyperlinks 49 is preferably repeated on the screens and user interfaces of systems in accordance with the present invention.

Selecting History hyperlink 52 preferably provides the user with historical information related to training courses that the user has previously completed (not shown) and can also be configured to provide the user with the ability to view and print completion certificates, course scores, and related information, for example.

The exemplary Training To Do List Screen 48, as shown, also preferably includes various other hyperlinks that provide functionality and information to the user and can vary depending on the type of user that is logged in to the system. For example, depending on the assigned role of the user, Training To Do List Screen 48 can also be configured to allow the user to manage action items for one or more users, manage information databases, manage information directed to injuries, and manage information directed to drills, as several examples. Any desired functionality can be included in Training To Do List Screen 48 depending on the needs of a particular organization using a system in accordance with the present invention.

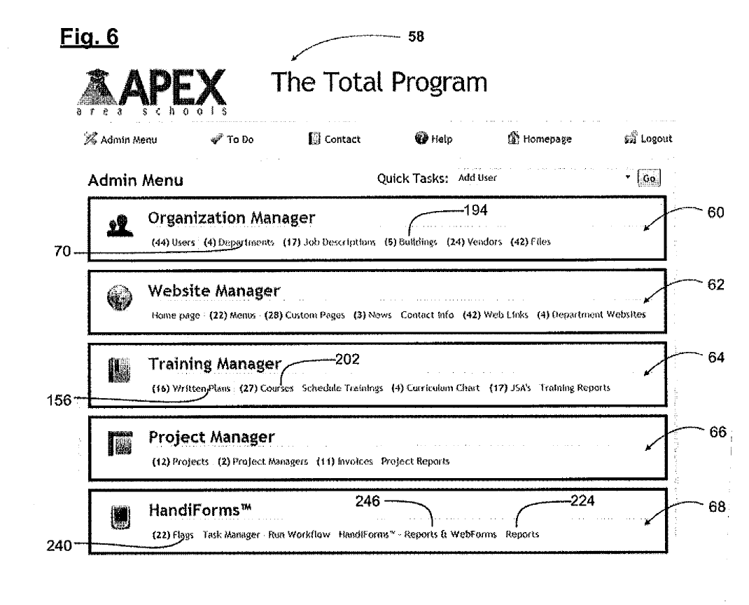

Further referring to FIG. 5, Training To Do List Screen 48 preferably includes Admin Menu hyperlink 56. Selecting Admin Menu hyperlink 56 preferably directs a user with appropriate permission to the exemplary Admin Menu 58 shown in FIG. 6. That is, Admin Menu 58 is preferably accessible only to users with predetermined privileges for management of the system such as users characterized as administrators. Admin Menu 58 is preferably configured for the particular organization using a system in accordance with the present invention and preferably provides hyperlinks that allow the system to be managed as desired.

As shown, the exemplary Admin Menu 58 comprises a group of hyperlinks directed to management of the Organization 60, a group of hyperlinks directed to management of the Website 62, a group of hyperlinks directed to the management of Training 64, a group of hyperlinks directed to the management of Projects 66, and a group of hyperlinks directed to the management of HandiForms™ (data collection) 68, all of which are preferably configured to function as described. Admin Menu 58 also preferably includes hyperlinks that allow the user to access other desired functionality of the system such as the ability to access a to do list, contact information, the organization homepage, as well as a help database. It is contemplated, however that Admin Menu 58 may be organized in any desired way for a particular organization and may include any desired information and functionality.

Hyperlinks related to management of the organization can include links that provide user information, department information, job description information, building information, and vendor information, as well as the ability to edit such information. Hyperlinks related to the management of the website can function to allow editing of the homepage, menu links, news items, contact information, and the like, and function to allow a user to create custom HTML pages, create custom links, and create department WebPages, for example. Hyperlinks directed to management of training can provide access to and management of information related to written plans, courses, training schedules, curriculum charts, job safety analyses, and training reports, as several examples. Hyperlinks directed to project management preferably function to track projects and finances and can provide access to and management of information related to projects, project managers, invoices, and project reports, as several examples. Hyperlinks directed to HandiForms™ preferably function to manage data collection and data management as is described in more detail below.

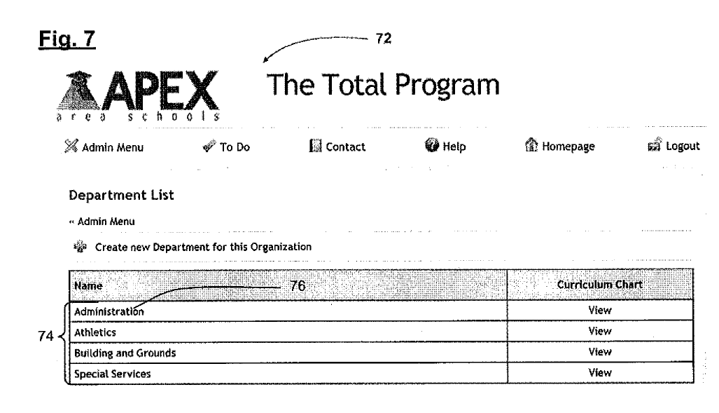

Continuing to refer to FIG. 6, the exemplary group of hyperlinks directed to the management of the organization 60 includes Departments hyperlink 70. Selecting Departments hyperlink 70 preferably directs the user to the exemplary department screen 72 shown in FIG. 7. As shown, department screen 72 provides a list of department hyperlinks 74 for the organization that allows the user to select and manage a desired department.

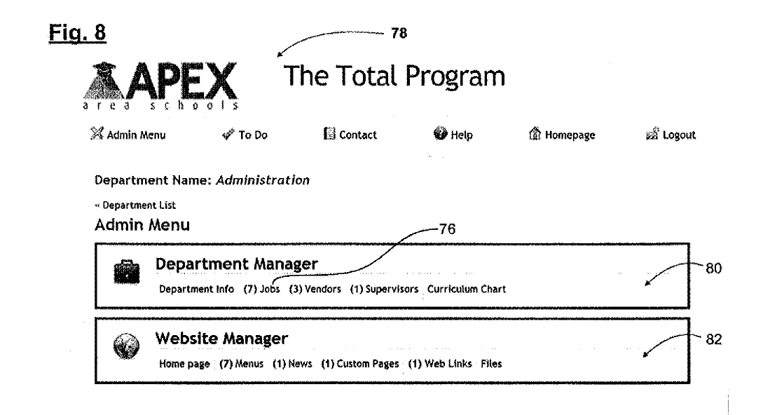

Various aspects of a Department of an organization can be managed from department screen 72. As an example, selecting the Administration hyperlink 76 directs the user to Administration Department screen 78 shown in FIG. 8, which allows the user to perform management functions related to the Administration Department of the organization. Accordingly, Administration Department screen 70 preferably comprises hyperlinks directed to a Department Manager 80 and a Website Manager 82.

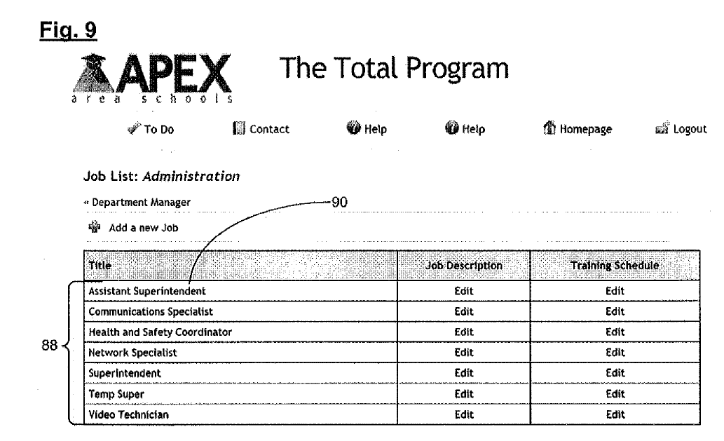

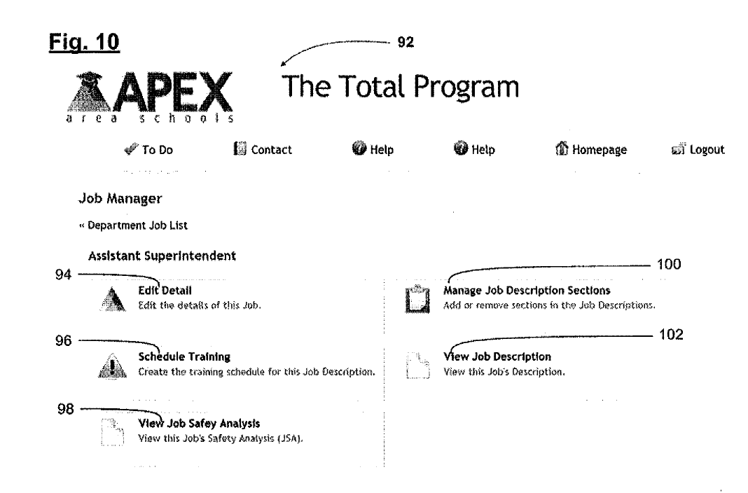

Selecting the Jobs hyperlink 84 from the group of Department Manager hyperlinks 80 of the Administration Department screen 78 directs the user to Job List screen 86 as can be seen in FIG. 9. Job List screen 86, as shown, includes a list of Job hyperlinks 88. Selection of a job from the list of Job hyperlinks 88, such as Assistant Superintendent hyperlink 90, preferably directs the user to exemplary Job Manager screen 92 as can be seen in FIG. 10.

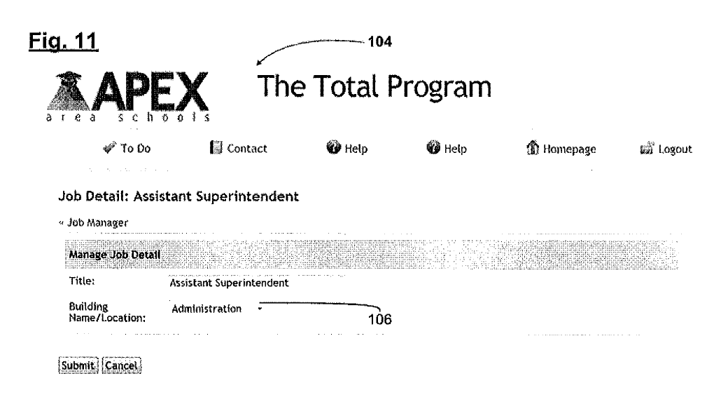

Management of a particular job within a department of an organization can be performed within Job Manager screen 92. As shown, Job Manager screen 92 includes Edit Detail hyperlink 94, Schedule Training hyperlink 96, View Job Safety Analysis hyperlink 98, Manage Job Description Sections hyperlink 100, and View Job Description hyperlink 102, all of which are preferably configured to function as described. Selection of Edit Detail hyperlink 94 preferably directs the user to Job Detail screen 104 shown in FIG. 11. As shown, Job Detail screen 104 includes drop-down list 106 that can be used to associate a specific job with a predetermined building.

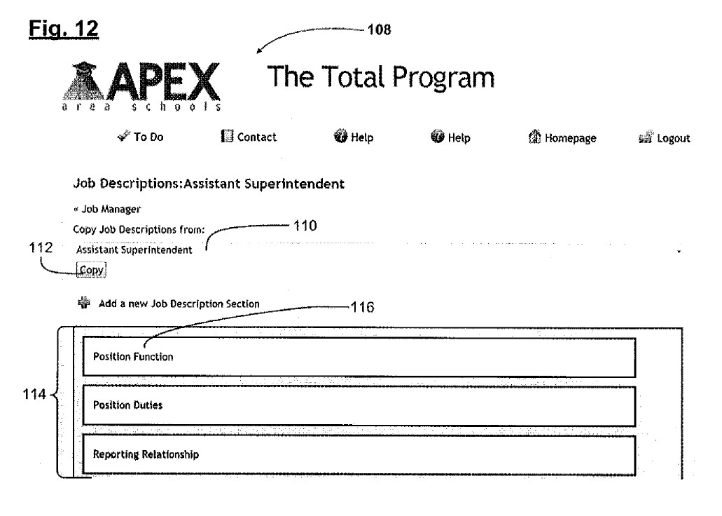

Selection of Managed Job Description Sections hyperlink 100 preferably directs the user to exemplary Job Description screen 108 shown in FIG. 12. Job Description screen 108, as shown, is used to define and manage a job description. A job description describes the requirements and tasks to be provided by a given employee. The job description may include information related to typical duties performed, minimum qualifications, supervision received, knowledge, and skills and abilities, for example. If desired, a job description (or any desired portion thereof) for any desired existing job can be copied and used as the basis for a new job description by selecting the desired job from the drop-down list of jobs 110. Selecting Copy button 112 functions to add job description sections from the existing job description to the job description section 114 of Job Description screen 108 as desired. Within Job Description screen 108 job description sections can preferably be rearranged by dragging and dropping job description sections as desired.

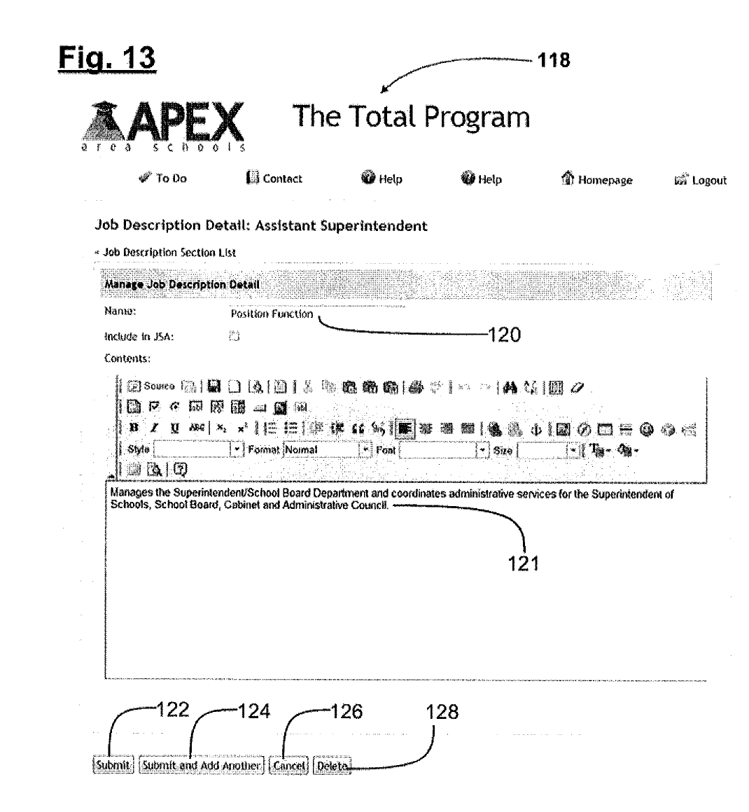

Individual job description sections can be edited by selecting the hyperlink associated with the job description section desired be edited. For example, referring to Job Description section 114 of Job Description screen 108, selecting Position Function hyperlink 116 preferably directs the user to exemplary Job Description Detail screen 118 shown in FIG. 13. As shown, Job Description Detail screen 118 comprises job description portion name field 120 wherein the name of the job description portion is defined. As shown, Job Description Detail screen 118 preferably comprises text editing functionality that can be used to create and edit text 121 associated with a particular job description section. Buttons that function to handle a job description section created by Job Description Detail screen 118 include Submit 122, Submit and Add Another 124, Cancel 126, and Delete 128 buttons each of which function as described.

Additionally, Job Description Detail screen 118 preferably includes checkbox 130 that, when checked, functions to cause the job description section to automatically be included in a job safety analysis. A job safety analysis is a safety analysis performed on each job description to identify the hazards a person performing the job may encounter while performing the job duties. The job safety analysis may also prescribe training and safety equipment needs, for example. The job description content sections are preferably included in a job safety analysis because the content sections in the job descriptions are frequently used in a job safety analysis. Configuring systems in accordance with the present invention to function in this manner advantageously saves time in the creation of a job safety analysis in accordance with the present invention. The maintenance of such information is also reduced as it is possible to update the job description section so the change is reflected in the job safety analysis.

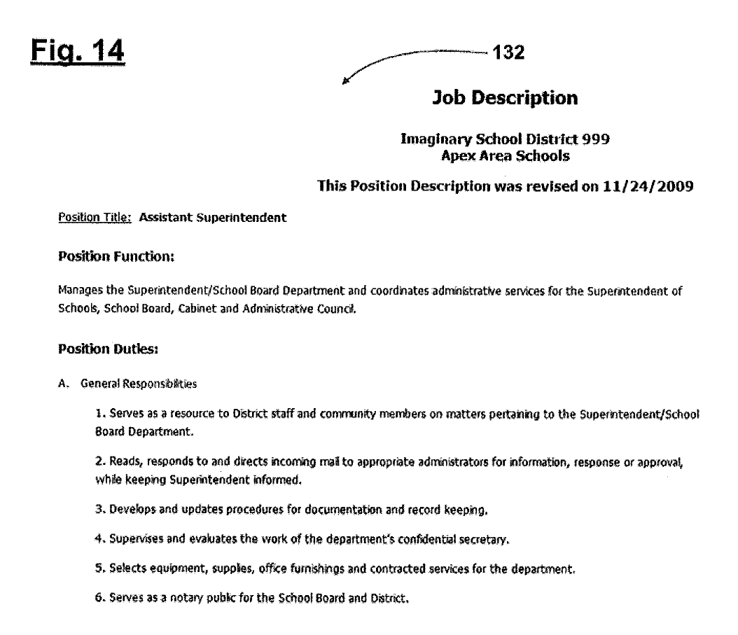

Referring back to Job Manager screen 92 of FIG. 10, selection of View Job Description hyperlink 102 directs the user to the job description associated with Job Manager screen 92. The exemplary Job Manager screen 92 is directed to the job title of Assistant Superintendant. Accordingly, selecting View Job Description hyperlink 102 directs the user to job description 192 as can be seen in FIG. 14.

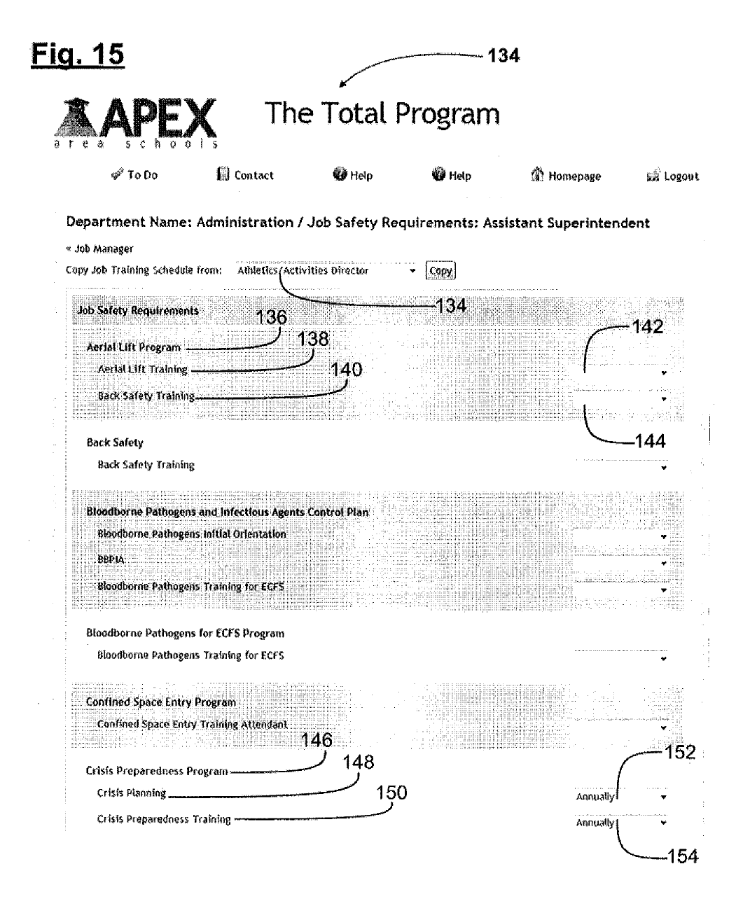

Referring back to Job Manager screen 92 of FIG. 10, selection of View Job Safety Analysis 98 directs the user to the exemplary Job Safety Requirements screen 134 shown in FIG. 15. Job Safety Requirements screen 134 is preferably configured to create an association between job descriptions, written plans, and safety trainings. Preferably, Job Safety Requirements screen 134 identifies all of the written plans and the safety trainings associated with each written plan. A written plan is a document containing a plan or strategy for helping to minimize the risk of a hazard. A written plan may include a plan to remove or mitigate exposure or training to help employees work around the hazard safely.

As shown, Job Safety Requirements screen 134 preferably includes a drop-down list 134 that can be used to copy any desired job training schedule from any desired existing job training schedule. Job Safety Requirements screen 134 also preferably includes plural sections that each identify a written plan, the trainings associated with that particular written plan, and an indication of the need and frequency for the identified training. The identified written plans and trainings can be configured as hyperlinks that direct a user to any desired screen or user interface such as a document, editor, scheduler, or the like.

As an example, Job Safety Requirements screen 134 identifies an Aerial Lift Program written plan 136. Written plan 136 includes Aerial Lift Training 138 and Back Safety Training 140. As shown, Aerial Lift Training 138 has drop-down list 142, which in the illustrated example is blank. Similarly, Back Safety Training 140 has drop-down list 144, which is also blank. In the illustrated exemplary Job Safety Requirements screen 134 a blank field for a drop down list associated with a safety training indicates that that particular safety training is not required for the job associated with Job Safety Requirements screen 134. When a safety training is needed for the job associated with Job Safety Requirements screen 134 the drop-down list associated with safety training will indicate the frequency that the safety training is needed.

Regarding the use of a drop-down list to identify a need and frequency of a safety training, Job Safety Requirements screen 134 also identifies Crisis Preparedness Program written plan 146, which comprises Crisis Planning safety training 148 and Crisis Preparedness Training safety training 150. Crisis Planning safety training 148 and Crisis Preparedness Training safety training 150 which include drop-down lists 152 and 154, respectively. As shown, drop-down lists 152 and 154 that the associated training is required and that the associated training should be done on an annual basis.

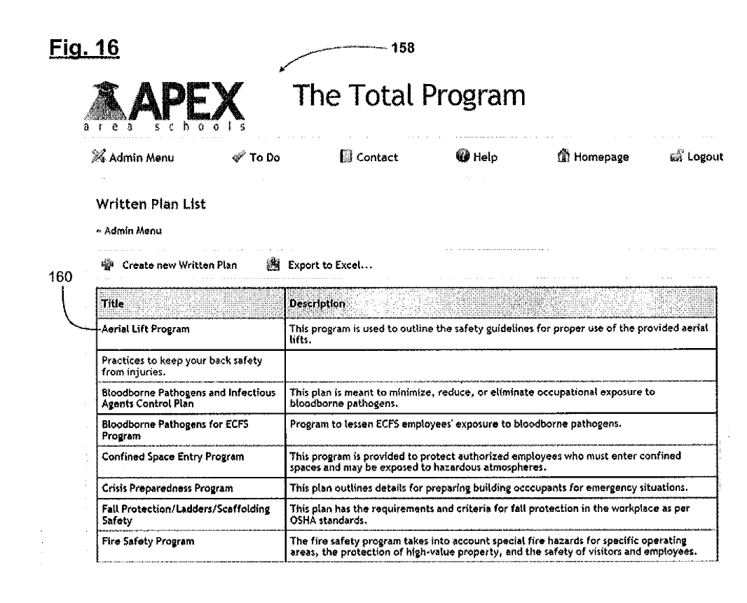

Next, referring back to Admin Menu 58 shown in FIG. 6 selecting the Written Plans hyperlink 156 from the group of training hyperlinks 64 directs the user to the exemplary Written Plan List screen 158 shown in FIG. 16. Written Plan List screen 158 preferably provides a list of written plans for the organization (or department or the like) logged into the safety system. As shown, written plans are preferably identified by title and also preferably include a brief description. From the Written Plan List screen 158 new written plans can be created as desired, exported, or otherwise managed and any desired manner.

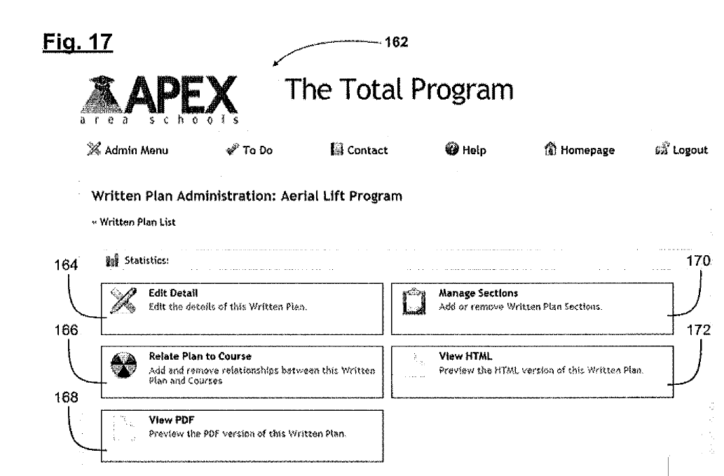

The written plans identified in Written Plan List screen 158 preferably comprises hyperlinks that direct the user to a written plan management screen for the selected written plan. As an example, selecting Arial List Program hyperlink 160 directs the user to the exemplary Written Plan Administration screen 162 shown in FIG. 17.

Written Plan Administration screen 162 preferably comprises hyperlinks that allow a user to perform various tasks related to administration of written plans. For example, Written Plan Administration screen 162, as shown, includes Edit Detail hyperlink 164, Relate Plan to Course hyperlink 166, View PDF hyperlink 168, Manage Sections hyperlink 170, and View HTML hyperlink 172, all of which are preferably configured to function as described. Written Plan Administration screen 162 may be configured to comprise any desired hyperlinks to provide any desired function.

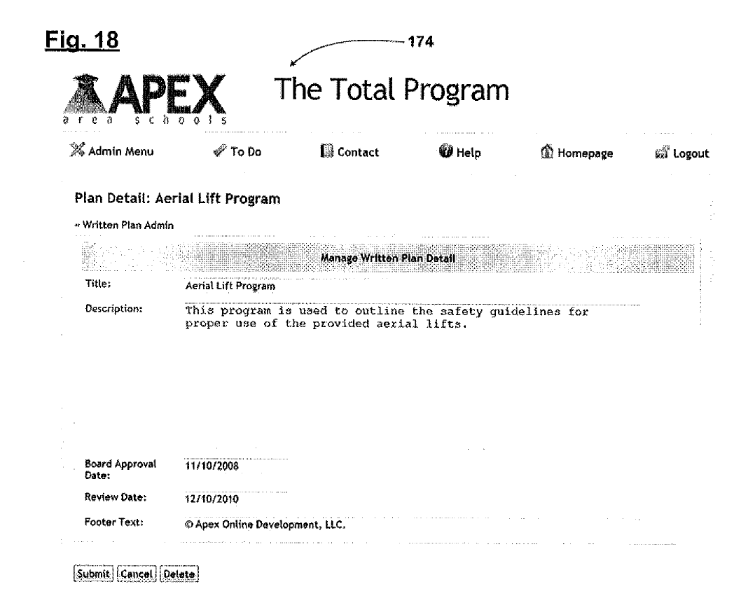

Continuing to refer to Written Plan Administration screen 162 shown in FIG. 17, selection of Edit Detail hyperlink 164 directs the user to the exemplary Plan Detail screen 174 shown in FIG. 18. Preferably, and as illustrated, Plan Detail screen 174 comprises an editor that allows the user to review, modify, and otherwise manage a written plan. Depending on the particular organization using the safety system Plan Detail screen 174 can also include fields that track approval dates, review dates, and the like. The system is preferably configured to automatically update and identify the review date of a written plan any time the written plan is modified.

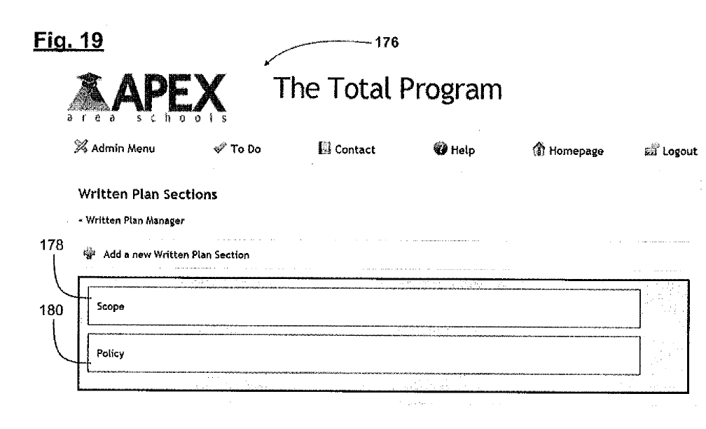

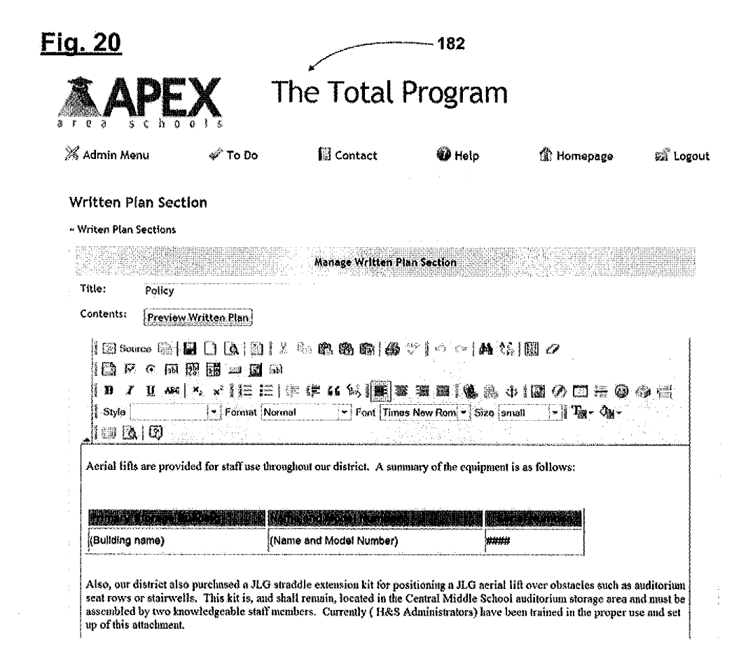

Continuing to refer to Written Plan Administration screen 162 shown in FIG. 17, selection of Manage Sections hyperlink 170 directs the user to the exemplary Written Plan Sections screen 176 shown in FIG. 19. As shown, Written Plan Sections screen 176 preferably allows the user to manage sections of a written plan. As shown, Written Plan Sections screen 176 identifies Test section 178 and Policy section 180, which are both preferably configured as hyperlinks that direct the user to an editor such as the exemplary Written Plan Section editor 182 shown in FIG. 20 with respect to Policy section 180. Additionally, when a section of a written plan is modified, the written plan is preferably automatically generated in a predetermined form such as a PDF document or the like.

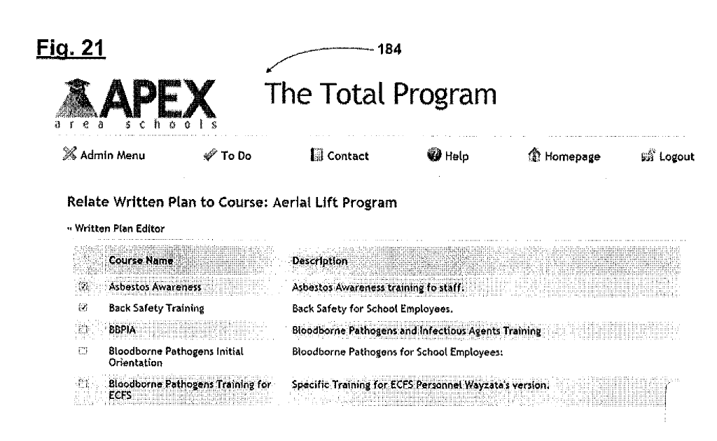

Continuing to refer to Written Plan Administration screen 162 shown in FIG. 17, selection of Relate Written Plan to Course hyperlink 166 directs the user to the exemplary Relate Written Plan to Course screen 184 shown in FIG. 21. Relate Written Plan to Course screen 184, as shown, allows the user to see a list of courses (safety trainings) and any desired information related to the written plans such as a brief description of the course or the like. At the Relate Written Plan to Course screen 184 training courses can be automatically related to written plans, which advantageously provides information used to relate written plans, job descriptions, job safety analyses, and training courses to each other in accordance with the present invention. Specifically, user can select a check box associated with any desired courses that are to be associated with the written plan that is the subject of the Written Plan Administration screen 162.

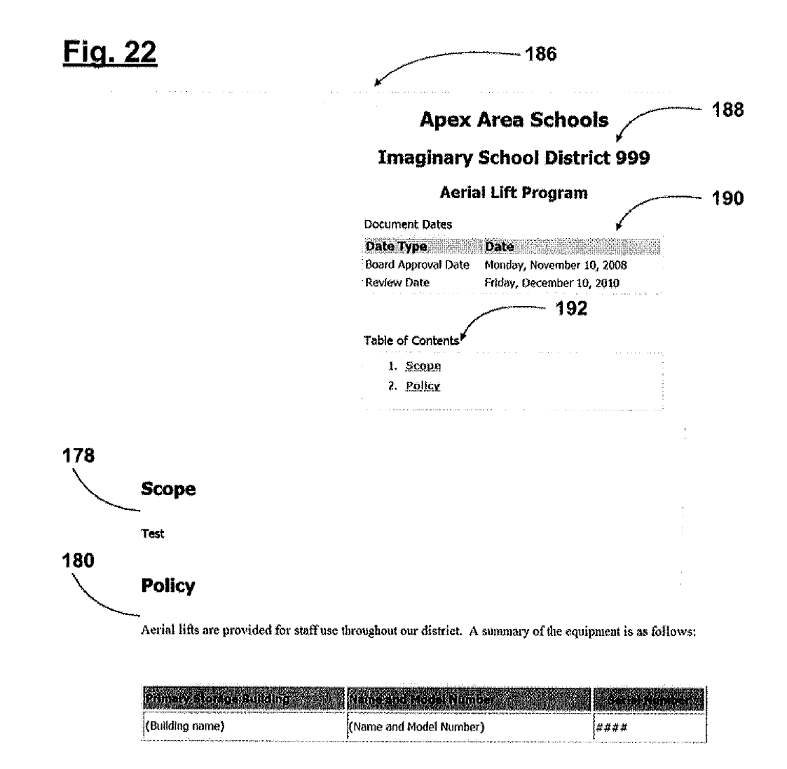

An exemplary written plan 186 that has been generated by a safety system in accordance with the present invention such as by using the functionality associated with Written Plan Administration screen 162 is shown in FIG. 22. As shown, written plan 186 comprises header information 188 that is preferably generated from organization information provided to the system. Written plan 186 additionally preferably includes document dates information 190 that provides information related to any desired dates associated with written plans such as approval dates, review dates, edit dates, and the like. Dates information 190 is preferably provided by using the functionality associated with the Plan Detail screen 174 shown in FIG. 18. Further referring to FIG. 22, written plan 186 also preferably includes written plan sections 178 and 180, which are created and managed using the functionality associated with Written Plan Sections screen 176 as described above with respect to FIG. 19. A Table of Contents 192 is also preferably automatically generated by the safety system and included in written plan 186.

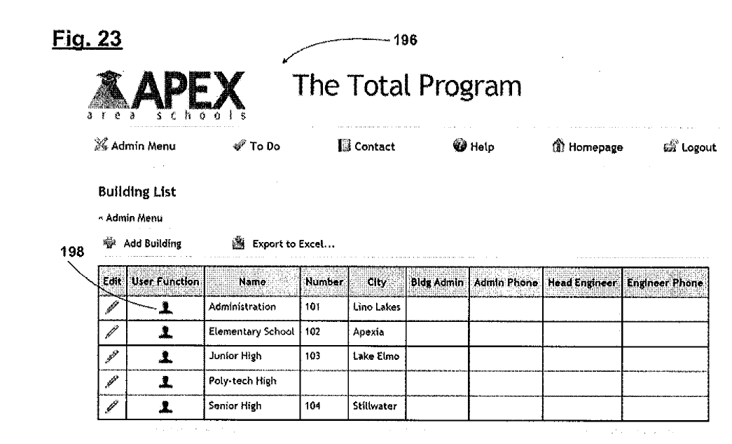

Next, referring back to Admin Menu 58 shown in FIG. 6 selecting the Buildings hyperlink 194 from the group of organization hyperlinks 60 directs the user to the exemplary Building List screen 196 shown in FIG. 23. Buildings List screen 196 preferably provides a list of buildings for the organization (or department or the like) logged into the safety system. As shown, Buildings List screen 196 also preferably provides information related to each building such as an address, phone number, and personnel information, for example. From the Building List screen 196 new buildings can be created as desired, exported, or otherwise managed in any desired manner.

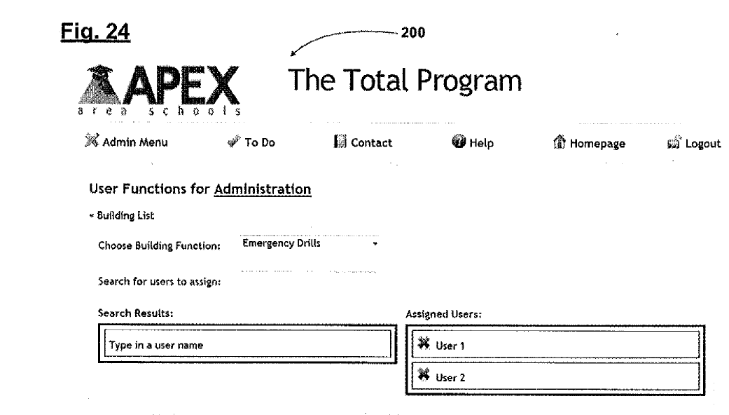

Building List screen 196 also preferably includes the ability to control user functions. For example, selecting the user function icon 198 associated with the Administration building directs the user to the exemplary User Function screen 200 shown in FIG. 24. In this manner, it is possible to control access of a particular user to features, reports, data, and the like, as desired.

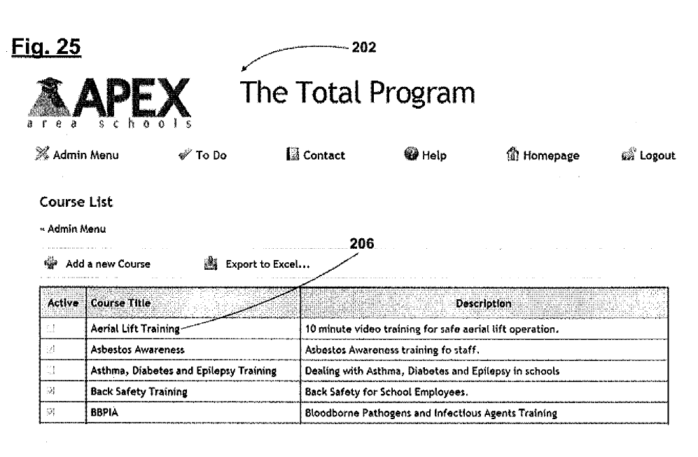

Again referring back to Admin Menu 58 shown in FIG. 6 selecting the Courses hyperlink 202 from the group of training hyperlinks 64 directs the user to the exemplary Course List screen 204 shown in FIG. 25. Course List screen 204 preferably provides a list of courses for the organization (or department or the like) logged into the system. As shown, Course List screen 204 also preferably provides a brief description of each course. From the Course List screen 204 new courses can be created as desired, exported, or otherwise managed and any desired manner.

Systems in accordance with the present invention are preferably configured to automatically schedule courses such as safety trainings and the like. The system can also be configured to suggest to a training administrator or human resources professional what training courses should be assigned to certain users or job descriptions. When adding trainings in the User Manager, the system preferably displays the current list of courses the user is registered for. There is also a list of available courses. In the available course list, the courses associated with a job safety analysis are preferably checked as suggested courses to add to the users To Do list.

Systems in accordance with the present invention can also be configured to log the trainings that occur in a classroom setting. The system can be configured so the trainer can select a course and create a sign in sheet. The students complete the classroom training and sign the sign in sheet. The system can also be configured so that trainer selects the students that participated and can upload documents associated with the training (such as the sign in sheet, exams, and other materials). The trainer can also assign the training to those students who were scheduled to attend the classroom training, but did not attend. The assignment can be for future classroom training or as an online assignment, for example.

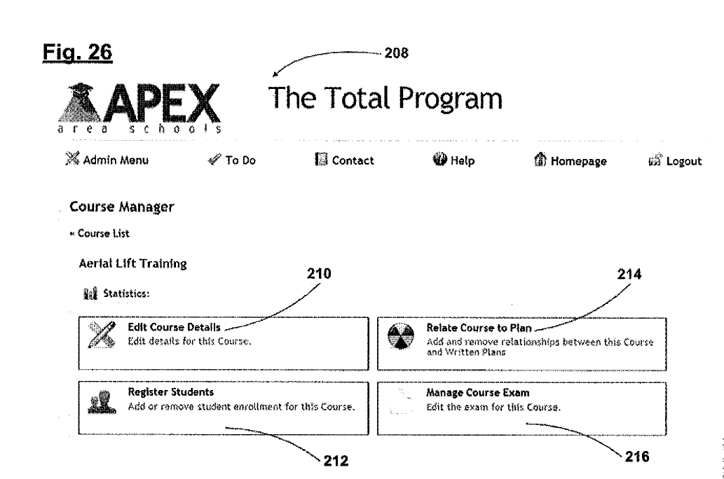

Continuing to refer to Course List screen 204 shown in FIG. 25, each course list is preferably hyperlinked to the course manager. For example, selecting Aerial Lift Training hyperlink 206 directs the user to the exemplary Course Manager screen 208 shown in FIG. 26. Course Manager screen 206 as shown, preferably includes Edit Course Details hyperlink 210, Register Students hyperlink 212, Relate Course to Plan hyperlink 214, and Manage Course Exam hyperlink 216 all of which are preferably configured to function as described.

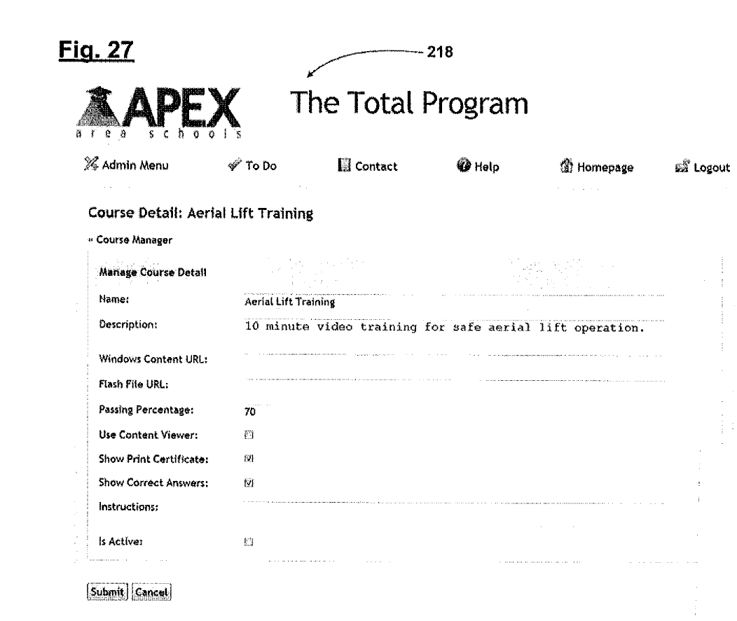

With reference to Course Manager screen 208 shown in FIG. 26, selecting Add Course Details hyperlink 210 directs the user to the exemplary Course Detail screen 218 shown in FIG. 27. Course Detail screen 218 allows the user to manage any desired aspects of a predetermined safety training course.

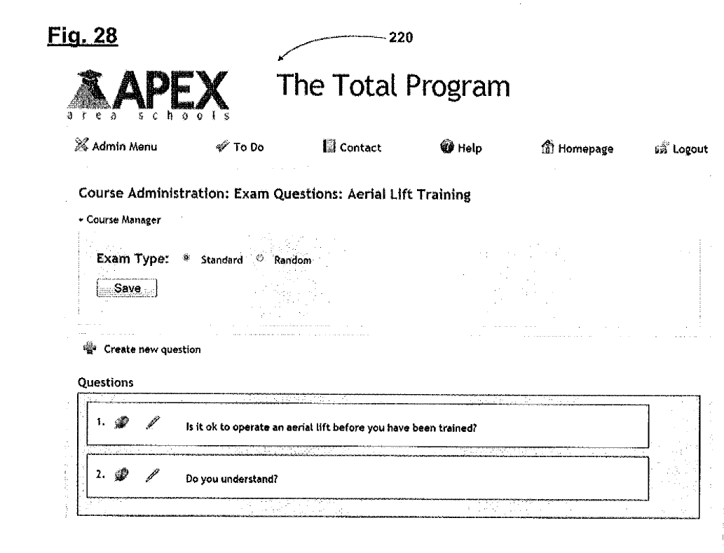

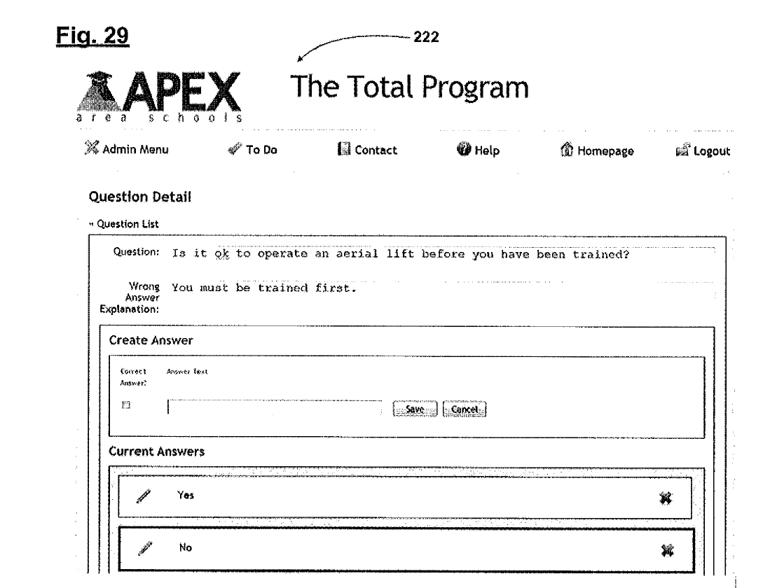

Further referring to Course Manager screen 208 shown in FIG. 26, selecting Manage Course Exam hyperlink 216 directs the user to the exemplary Course Administration screen 220 shown in FIG. 28. Course Administration screen 220 allows the user to manage any desired aspects of a predetermined safety training course such as course type, questions asked, arrangement or order of questions, creation of new questions, and modification of existing questions, for example. Question Detail screen 222 shown in FIG. 29 illustrates an exemplary screen that can be provided to allow user to edit or modify a desired question.

Safety systems in accordance with the present invention also preferably include data management functionality. In the context of a school system as a user of a system of the present invention there are typically safety compliance activities that are either suggested or required by oversight organizations such as a state department of education and a state or federal organization. For example, the Occupational Safety and Health Administration (OSHA) provides enforcement of safety and health legislation in various organizations. Any of these organizations can designate compliance activities that an organization such as school system must comply with. Safety systems in accordance with the present invention also advantageously allow a user to manage the necessary activities required to provide such compliance as well as to provide any desired or necessary documentation or tracking functions related to such compliance activities.

As an example, a safety system in accordance with the present invention can be configured to create a work order from a compliance survey required by an oversight organization such as OSHA or the like. Additionally, systems in accordance with the present invention can create work orders from any desired source such as from Web links, Web services, documents, other software, as well as from devices such as desktop computers, handheld devices such as phones, and handheld devices that may include a sensor or the like used to measure a desired parameter. When a work order is created, systems in accordance with the present invention can be configured to provide flags (alerts, notifications, or the like) that are associated with predetermined users such as an employee responsible for handling such work order.

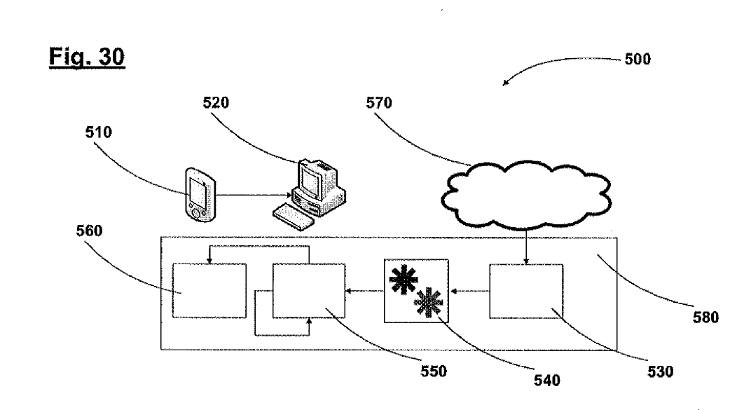

Referring to FIG. 30, a schematic representation of a data management system 500 in accordance with the present invention is shown. Preferably, data management system 500 is configured to collect, process, and track data such as data related to compliance management. Data management system 500 is also preferably configured to assign tasks related to activities needed based on collected data. As illustrated, data management system 500 comprises survey module 580 and it is contemplated that data management system 500 may comprise any desired additional modules directed to any desired data management activities. Module 580 receives input information from devices such as handheld device 510 and computer 520 through a network 570. Data input can be provided in any desired way and does not need to be provided via a network or by any specific device. Exemplary data that can be collected comprises data obtained from a health or safety survey, or the like, for example.

Data provided to module 580 is preferably logged in a database table 530. A workflow engine 540 preferably processes the data according to user parameters to identify issues or important data. A workflow preferably comprises a set of instructions that act upon a given survey dataset. HandiForms™ is preferably configured so each organization may use a standard workflow or an organization may use a custom workflow. The workflow may be started manually by a user or by some automated process such as a Windows Service. The purpose of a workflow is to process the data entered in the surveys and identify any issues that need to be addressed. These issues are referred to as flags and are described in further detail below. The flags may be identified by the workflow instructions. For example, during the data collection process, a CO2 reading may be collected. If that reading is above a given level, then a flag is preferably created. The level may be set by the user during the configuration of the workflow. The workflow preferably keeps track of which questions have been addressed and which questions still need to be processed. When a flag is created it is useful to store the identifier of the original survey question so the identifier can be referred to by the user addressing the flag.

The workflow may include complex assignment rules. Some data elements used to make the assignments may include the organization, survey, question, question value, building, and date and time created, for example. The assignment rules are preferably added to the workflow instructions during the configuration process. Those rules are then preferably bound to a given organization and HandiForm™. One or more organizations may share the same set of rules. As an example, a survey questions may ask if there is mold in a room. The workflow is preferably configured to assign a flag to the building engineer for that building.

Data that is identified as being related to the parameters set by the user, such as data that indicates the need for action item, is stored in the flag table 550. The data in the flag table 550 is preferably assigned to a predetermined user of the system. That is, data that indicates the need for an action item is preferably processed by the workflow engine 540 to create a flag that is associated with a predetermined user. The workflow engine 540 preferably identifies what action is needed and what user is responsible for handling the action item in creating the flag, for example. Preferably, workflow engine 540 is configured to run in the background. Workflow engine 540 preferably checks to run workflows once per day or other predetermined time period. Workflow engine 540 is also preferably configured so that a user can identify a desired workflow and caused the workflow to be processed at any desired time. Various data attributes can be stored with the flag including: Create date and time, Assignee, Survey, Survey question, Survey question response, Comments, Due date, Priority, Organization who performed the survey, Organization who the survey was performed for, Building, Flag Status, and Room identifier, as several examples.

Module 580 of data management system 500 also preferably functions to track data and information as output 560, such as by performing audits having predetermined parameters. For example, module 580 can be configured to track any desired activities related to generation and resolution of a flag including the data and parameters that created the flag in the activities that were undertaken to resolve the flag. Module 580 can also be configured to monitor and report on any desired data being processed by data management system 500.

Status of a flag can be configured by the user as desired. A key attribute of the flag status is whether the flag should be considered as closed or resolved. This helps systems in accordance with the present invention determine which flags are still active and need user attention. Because the system is multi-tenant, a third-party service provider or consultant can perform surveys for plural distinct users. Such service providers can advantageously identify which users they are performing the survey for and the systems in accordance with the present invention can handle she necessary is management for each user. Depending on configuration, such third-party service providers may have access to data or data may be routed directly to a user. The workflow engine 540 preferably looks in a table to determine which workflow should be processed based on the user identifier and the survey identifier. Each user may have a unique workflow for each survey or common workflows may be used for several users. Workflows may be linked together and configured accept parameters configured by the user. For example, workflows may comprise activities such as creation of a flag, dispatch of an e-mail, scheduling of an activity, and creation of records or other data management activities.

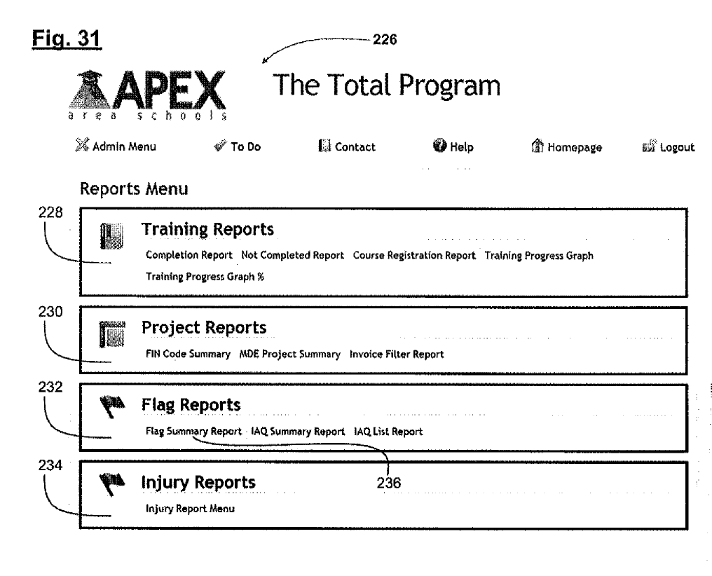

The HandiForms™ functionality of systems in accordance with the present invention relates to data management activities as described above. Generally, HandiForms™ provides a platform for developing and hosting survey applications and the like. A survey comprises a set of questions presented to a user or system. The questions get a response and are preferably logged into the HandiForms™ system. The response can be sent in real-time or synchronized in a batch. The data may be entered into the system as desired such as is described below. Some examples of Health and Safety surveys include classroom surveys, building surveys, ventilation surveys, water sampling surveys, radon sampling surveys, electrical safety surveys, kitchen safety surveys, pest management surveys, personal protective equipment surveys, hearing conservation surveys, forklift safety surveys, waste safety surveys, and respirator protection surveys. Such surveys can be as simple as a checklist or more complex like an Injury and Illness Incident Report required by OSHA. More complex survey typically require some information to be input to start the process and the remaining information can be entered later. Access to part of the data can be restricted to only certain users. The platform is flexible enough that the platform can take data from multiple sources as described below. Referring back to Admin Menu 58 shown in FIG. 6 selecting the Reports hyperlink 224 from the group of HandiForms™ hyperlinks 68 directs the user to the Reports Menu screen 226 shown in FIG. 31. As shown, Reports Menu screen 226 preferably includes a group of hyperlinks directed to Training Reports 228, a group of hyperlinks directed to Projects Reports 230, a group of hyperlinks directed to Flag Reports 232, and a group of hyperlinks directed to Injury Reports 234, all of which are preferably configured to function as described.

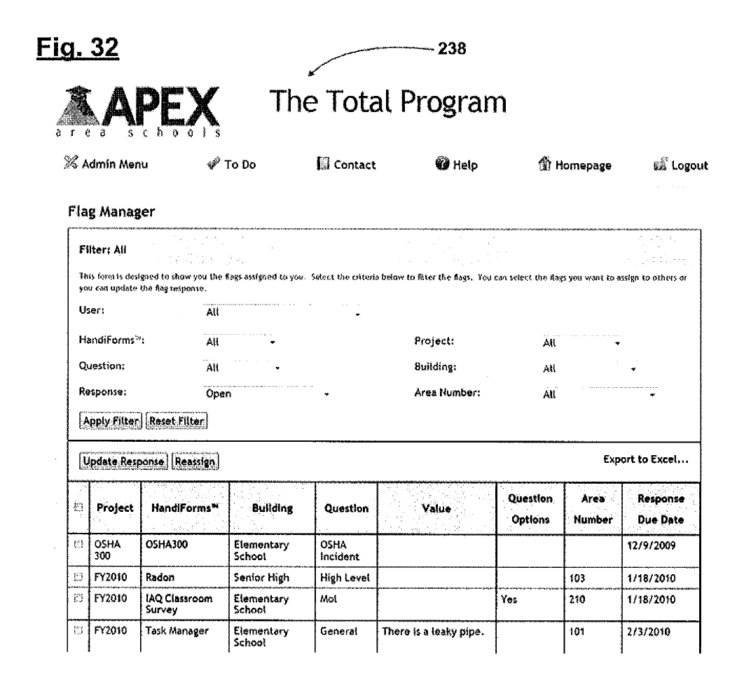

Selecting the Flag Summary Report hyperlink 236 from the Flag Reports group of hyperlinks 232 of the Reports Menu screen 226 shown in FIG. 31 directs the user to the Flag Manager screen 238 shown in FIG. 32. HandiForms™ preferably includes a resolution process referred to as the flag process. The flag process is designed to present issues identified by the workflow to a user or another system for resolution. A flag may be reassigned to another user, responded to, referred to another computer system (such as maintenance ticketing software) or piece of hardware (such as a programmable logic controller). If a flag is reassigned to another user, the flag is removed from the queue of one user and moved to the queue of another user. Flag Manager screen 238 provides a user with information related to flags (action items, alerts, or the like) assigned to that user. Flag Manager screen 238 is preferably configured so that the user can filter information based on any desired predetermined criteria. Additional functionality preferably provided by Flag Manager screen 238 relates to the ability of a user to update the status of a flag, modify or otherwise manage a flag, transfer a flag to another user, and the like. From the Flag Manager screen 238 flags can be created as desired, exported, or otherwise managed in any desired manner.

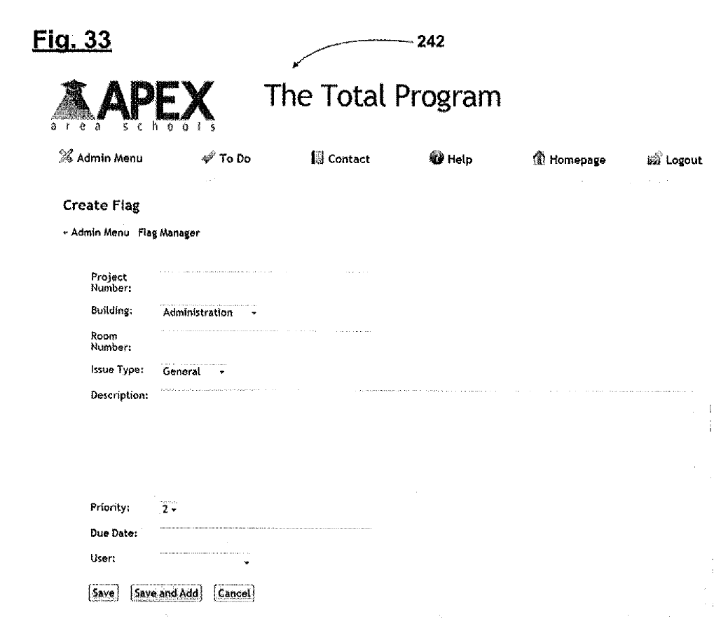

Flags can be created automatically by the system based on predetermined parameters or can be created by users. Referring back to Admin Menu 58 shown in FIG. 6 selecting the Flags hyperlink 240 trucks the user to Create Flag screen 242 shown in FIG. 33 that can be used by a user to create a flag. Because the Create Flag screen 242 is created from Admin Menu 58 certain parameters such as priority, due date, and assigned user can be set at Create Flag screen 242. Users without administrator privileges preferably access a separate flag creation screen that is configured based on the access privileges and functionality desired for a particular user. This

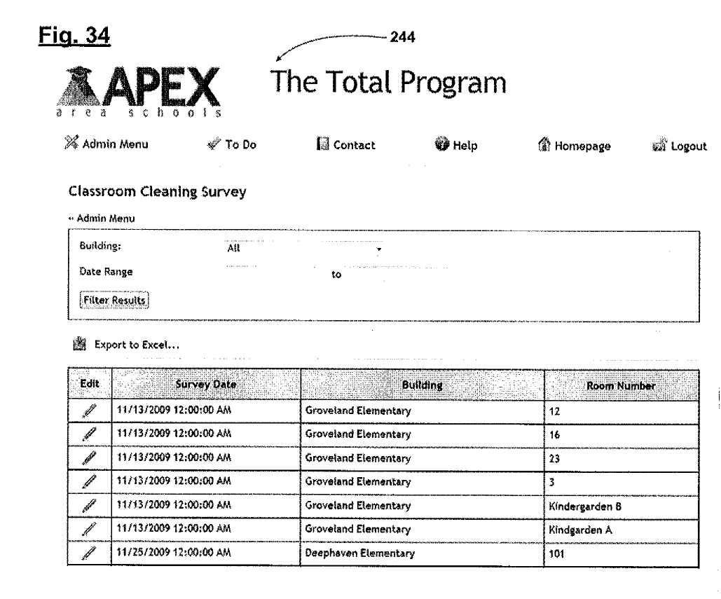

An exemplary survey that can be used in accordance with the present invention is shown in FIG. 34 as Classroom Cleaning Survey 244. Classroom Cleaning Survey 244 can be accessed from Admin Menu 58 shown in FIG. 6 by selecting the Reports & WebForms hyperlink 246 from the group of HandiForms™ hyperlinks 68. As described above surveys can be provided in any desired configuration depending on the needs of a particular user. Preferably, as shown, survey can be edited or otherwise managed from within the survey itself.

As described above, systems in accordance with the present invention can be used to manage trainings and to track compliance with activities such as those who acquired by an oversight organization. Referring to FIG. 35, an exemplary process 248 that a user can use to configure systems in accordance with the present invention is illustrated is a flowchart. It is noted that the illustrated steps do not need to be performed in the order described and illustrated steps can be omitted as desired. Moreover, additional steps can be added as appropriate or needed.

Step 1 shown in process 248 comprises identifying safety hazards that exist at a users workplace. Safety hazards are generally identified as anything that can potentially cause physical harm to an employee. Some common safety hazards include working at elevated heights, working with repetitive tasks, working in confined spaces, contacting certain chemical or biological materials, for example.

After safety hazards are identified, written plans are preferably developed and implemented as shown in step 2. Generally, a written plan comprises a document or electronic file that contains a plan or strategy to help minimize the risks associated with a safety hazard. Written plans may include a plan to remove or mitigate exposure or may include training protocols that provide information to employees needed to properly and safely deal with a safety hazard.

At step 3, in the event that safety hazards cannot be engineered out of a work environment, training courses are developed that function to provide information to employees regarding working with a particular safety hazard. Any particular safety hazard may have plural training courses. Accordingly, at step 4, training courses are preferably associated with hazards so that the training courses can be included in a job safety analysis.

An analysis of employee job duties is preferably performed at step 5 to define job descriptions for each employee. Plural employees may share the same job description. Job descriptions may include information such as typical duties performed, minimum qualifications, supervision received, knowledge, and skills and abilities, for example. Preferably, portions of job descriptions identified by the user are configured to be included in the job safety analysis.

At step 6, safety hazards that a particular job description may encounter in the workplace are preferably identified. At this step, the hazards and written plans for such hazards are preferably associated with job descriptions. Training schedules are then preferably developed based upon job descriptions at step 7. Preferably the user determines the frequency of a particular training.

Preferably, in accordance with the present invention, systems can be configured to use information such as the information used in steps 1 through 7 above to automatically schedule safety training for employees based upon job description as indicated at step 8. As indicated at step 9, systems in accordance with the present invention can be configured so training activity reports can be generated and provided to the user. Additionally, as indicated at step 10, systems in accordance with the present invention can also be configured to provide reminders or the like to employees scheduled for trainings.

Systems in accordance with the present invention can be provided by using one or more relational database management system (i.e. Microsoft SQL Server 2005), one or more web servers (i.e. Microsoft Windows Server 2003 and Internet Information Server 6.0), one or more reporting servers (i.e. Microsoft SQL Server Reporting Services 2005), one or more email servers (i.e. Microsoft Exchange Server 2003), a web browser (i.e. Microsoft Internet Explorer 7) for each client, one or more media servers (for files and videos), one or more mobile computing devices (i.e. Motorola MC-70), for example

The present invention has now been described with reference to several exemplary embodiments thereof. The entire disclosure of any patent or patent application identified herein is hereby incorporated by reference for all purposes. The foregoing disclosure has been provided for clarity of understanding by those skilled in the art. No unnecessary limitations should be taken from the foregoing disclosure. It will be apparent to those skilled in the art that changes can be made in the exemplary embodiments described herein without departing from the scope of the present invention. Thus, the scope of the present invention should not be limited to the exemplary structures and methods described herein, but only by the structures and methods described by the language of the claims and the equivalents of those claimed structures and methods.

What is claimed is:

1. A method of implementing a hazard training program including:
inputting a written plan addressing a predetermined hazard into a computer database;
indicating in the written plan at least one training module directed to the predetermined hazard;
automatically associating in a computer database the predetermined hazard with the at least one training module indicated in the written plan addressing the predetermined hazard;
inputting a job description describing a predetermined job into a computer database/memory;
indicating in the job description that the predetermined hazard will be encountered in performing the predetermined job;
automatically associating the training modules directed to the predetermined hazard with the job description; and
indicating in a user readable format that the training modules directed to the predetermined hazard are associated with the job description.

2. The method of claim 1 further including:
inputting at least one employee ID into a computer database;
associating the at least one employee ID with a job description;
automatically assigning training modules associated with the job description to the at least one employee ID; and
indicating in a user readable format a schedule of the training modules assigned to the at least one employee ID.

3. A computer program user interface for providing information concerning a facility training program including:
a first hyperlink indicating at least one department hyperlink associated with the facility, the at least one department hyperlink indicating a training curriculum associated with the at least one department;
a second hyperlink indicating at least one job name, the at least one job name having associated therewith at least a job description hyperlink and a job safety analysis; and
a third hyperlink indicating written plans for at least one hazard associated with the facility.

4. A computer program user interface for providing information concerning a facility training program including:
at least one written plan name associated with a facility or department, the at least one written plan name including a hyperlink to the complete associated written plan and having associated therewith at least one training module;
each training module associated with the at least one written plan;
at least one job title associated with the at least one written plan name, the job title having associated with it at least a first hyperlink to a job description associated with the job title and at least a second hyperlink to a job safety analysis associated with the job title; and
an indication of the frequency at which each training module must be completed for the job indicated by the at least one job title.
